(19) United States
(12) Patent Application Publication
(10) Pub. No.: US 2024/0417276 A1
(43) Pub. Date: Dec. 19, 2024

(54) METHOD FOR PREPARING IRIDIUM OXIDE

(71) Applicant: HEESUNG CATALYSTS CORPORATION, Siheung-si (KR)

(72) Inventors: Ho-Dong KIM, Incheon (KR); Dong Kun KANG, Siheung-si (KR); Minsik KIM, Ansan-si (KR); Youngsan YOO, Incheon (KR); Jung Min SEO, Suwon-si (KR)

(21) Appl. No.: 18/718,528

(22) PCT Filed: Dec. 12, 2022
(86) PCT No.: PCT/KR2022/020167

§ 371 Date: Jun. 11, 2024

(30) Foreign Application Priority Data
Dec. 14, 2021 (KR) 10-2021-0178920

(51) Int. Cl. C01G 55/00; C25B 11/047; H01M 4/90

(52) U.S. Cl. CPC C01G 55/004; C01G 55/001; C01P 2002/72; C01P 2006/12; C01P 2006/14; C01P 2006/16; C01P 2006/20; C25B 11/047; H01M 4/9025

(57) ABSTRACT

Provided is a method for preparing iridium oxide, comprising the steps of: preparing iridium chloride; mixing iridium chloride, a solvent and a pore control agent to prepare a dispersion; mixing the dispersion with an ion exchanging agent and performing ion exchange; removing the solvent from the dispersion to prepare a powder; and heat-treating the powder.

### TECHNICAL FIELD

Disclosed is a method for easily commercially preparing iridium oxide with a high pore volume and a high specific surface area as a catalyst for oxygen generation reaction that can be used in fuel cells and water electrolysis reactions.

### BACKGROUND ART

Fuel cell and water electrolysis technologies are attracting attention as a way to achieve carbon neutrality, but commercialization is delayed due to difficulties in solving catalyst durability problems.

When fuel cells and water electrolysis systems operate to generate electricity, water may be generated as a by-product and cover the surface of a catalyst, which may cause a reversal voltage phenomenon at a cathode due to insufficient hydrogen supply, and then, carbon, a catalyst support, may be oxidized by reacting with the water and by a high voltage, corroding the cathode. Accordingly, there may be a problem of deteriorating efficiency, stability, and durability of the catalyst.

As a method to solve the duration deterioration problem occurring at electrodes of the fuel cells and the water electrolysis systems, are known technologies of improving the durability to the reverse voltage phenomenon by introducing a catalyst for an iridium (Ir)-based oxygen evolution reaction (OER) to decompose the water before decomposing the carbon, an electrode catalyst carrier, and thus stabilize the electrode catalyst. The fuel cells operate according to Reaction Scheme 1 expressed as follows, wherein an oxygen evolution reaction catalyst, which decomposes the water (H₂O) generated therefrom to generate oxygen, operates according to Reaction Scheme 2.

Anode: H²→2H⁺+2e⁻

Cathode: ½O₂+2H⁺+2e⁻→H₂O

Overall: H₂+½O₂→H₂O+Heat [Reaction Scheme 1]

2H₂O→2H₂+O₂ [Reaction Scheme 2]

On the other hand, an iridium oxide (IrO₂) catalyst used in the oxygen evolution reaction must have a nano-sized particle and a high specific surface area to secure high performance.

However, if iridium metal is simply thermally oxidized at 1300° C. or higher and converted to oxide, the iridium oxide has a micron-sized large particle and also, a specific surface area of 30 m²/g or less due to the sintering, which may not perform as a catalyst.

Accordingly, there is a need for a method of easily commercially producing iridium oxide with a high pore volume and a high specific surface area.

### PRIOR ARTS

### Patent Document

Korean Patent Publication No. 10-2019-0018836
U.S. Pat. No. 8,263,290

### Non-Patent Document

International journal of hydrogen energy 43 2018, 19460-19467

### DISCLOSURE

### Technical Problem

One embodiment provides a method for preparing iridium oxide that can easily commercially prepare iridium oxide having a high pore volume and a high specific surface area from iridium metal.

### Technical Solution

According to an example embodiment, a method for preparing iridium oxide includes preparing iridium chloride, mixing iridium chloride, a solvent, and a pore control agent to prepare a dispersion, mixing the dispersion with an ion exchanging agent and performing ion exchange, removing the solvent from the dispersion to prepare a powder, and heat-treating the powder.

The preparing of the iridium chloride may include a mixing step of preparing a mixture of iridium metal powder and an alkali metal compound, a firing step of firing the mixture to prepare alkali-containing iridium oxide, a hydrochloric acid aqueous solution washing step of washing the alkali-containing iridium oxide with an aqueous hydrochloric acid solution to obtain iridium oxide, and a hydrochloric acid dissolution reaction step of dissolving the iridium oxide in hydrochloric acid under pressure and then performing a reaction.

The alkali metal compound may include alkali metal hydroxide, alkali metal peroxide, or a mixture thereof.

The alkali metal hydroxide may include sodium hydroxide, potassium hydroxide, lithium hydroxide, or a mixture thereof.

The alkali metal peroxide may include sodium peroxide, potassium peroxide, lithium peroxide, or a mixture thereof.

The alkali-containing iridium oxide may include a compound represented by Chemical Formula 1.

NaₓIr_{y}O_{z} [Chemical Formula 1]

In Chemical Formula 1, x is an integer from 2 to 4, y is an integer from 1 to 3, and z is an integer from 3 to 8.

In the hydrochloric acid aqueous solution washing step, a concentration of the aqueous hydrochloric acid solution may be 5% to 10%.

The hydrochloric acid dissolution reaction step may be performed at 130° C. to 170° C. for 2 to 6 hours under 5 to 10 pressures.

In the step of preparing the dispersion, the solvent may be an alcohol-based mixed solvent.

The alcohol-based mixed solvent may include ethanol and isopropanol.

A weight ratio of isopropanol and ethanol may be 4:6 to 6:4.

In the step of preparing the dispersion, the solvent may be mixed in an amount of 10 to 20 parts by weight based on 1 part by weight of iridium chloride.

The pore control agent may be a compound including a benzene ring or a hydrocarbon compound having 6 to 10 carbon atoms.

The pore control agent may include 1,2,3-trimethylbenzene, 1,2,4-trimethylbenzene, 1,3,5-trimethylbenzene, triethylbenzene, hexanol, xylene, toluene, butylacetate, octanol, or a mixture thereof.

A molar ratio of iridium chloride and the pore control agent may be 1:1 to 1:3.

The ion exchanging agent may be an alkali metal nitrate.

A molar ratio of iridium chloride and ion exchanger may be 1:5 to 1:10.

The ion exchange may be performed between 70° C. and 90° C.

The step of preparing the powder may be performed by drying at 150° C. to 180° C. for 12 hours or more.

The heat-treating may be performed at 300° C. to 600° C. for 1 hour to 1.5 hours.

The prepared iridium oxide may have an average pore size of 2 nm to 5 nm, an average pore volume of 0.21 cm³/g to 0.25 cm³/g, and a specific surface area of 100 m²/g to 420 m²/g.

### Advantageous Effects

The method for preparing iridium oxide according to an embodiment can easily commercially prepare iridium oxide having a high pore volume and a high specific surface area from iridium metal.

### DESCRIPTION OF THE DRAWINGS

FIG. 1 is a process flow chart showing steps for preparing iridium oxide according to an embodiment.

FIG. 2 is a process flow chart showing the iridium chloride preparation steps in FIG. 1.

FIG. 3 is a photograph showing the products at each stage of manufacturing iridium oxide in Example 1.

FIG. 4 is a graph showing the results of X-ray diffraction analysis (XRD) of iridium oxide prepared in Examples 1 to 4.

### MODE FOR INVENTION

The advantages, features, and aspects to be described hereinafter will become apparent from the following description of the embodiments with reference to the accompanying drawings, which is set forth hereinafter. However, the present invention may be not limited to embodiments that are described herein. Although not specifically defined, all of the terms including the technical and scientific terms used herein have meanings understood by ordinary persons skilled in the art. The terms defined in a generally-used dictionary may not be interpreted ideally or exaggeratedly unless clearly defined. Throughout the specification and claims which follow, unless explicitly described to the contrary, the word “comprise/include” or variations such as “comprises/includes” or “comprising/including” will be understood to imply the inclusion of stated elements but not the exclusion or any other elements.

Further, the singular includes the plural unless mentioned otherwise.

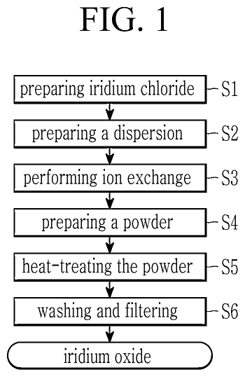

FIG. 1 is a process flow chart showing steps for preparing iridium oxide according to an embodiment.

Referring to FIG. 1, a method for preparing iridium oxide will be described in detail.

The method for preparing iridium oxide includes an iridium chloride preparation step (S1), a dispersion preparation step (S2), an ion exchange step (S3), a powder preparation step (S4), and a heat treatment step (S5).

For example, in the iridium chloride preparation step (S1), iridium chloride may be prepared from iridium metal powder.

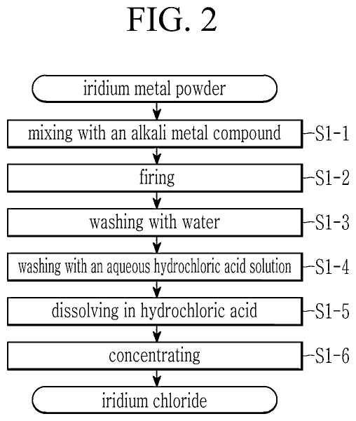

FIG. 2 is a process flow chart showing the steps for preparing iridium chloride.

Referring to FIG. 2, a method for preparing iridium chloride will be described in detail.

The method for preparing iridium chloride includes an alkali metal compound mixing step (S1-1), a sintering step (S1-2), a washing step with a hydrochloric acid aqueous solution (S1-4), and dissolving in hydrochloric acid and reaction step (S1-5).

In the alkali metal compound mixing step (S1-1), a mixture of iridium metal powder and an alkali metal compound is mixed.

The alkali metal compound may include an alkali metal hydroxide, an alkali metal peroxide, or a mixture thereof, for example, a solid mixture of an alkali metal hydroxide and an alkali metal peroxide.

The alkali metal hydroxide may include sodium hydroxide, potassium hydroxide, lithium hydroxide, or a mixture thereof, and for example, the alkali metal hydroxide may be sodium hydroxide (NaOH).

The alkali metal peroxide may include sodium peroxide, potassium peroxide, lithium peroxide, or a mixture thereof, and for example, the alkali metal peroxide may be sodium peroxide (Na₂O₂).

As an example, the alkali metal hydroxide may include a mixture of sodium hydroxide and sodium peroxide.

The mixture may include an alkali metal compound in an amount of 0.5 parts by weight to 1 part by weight, for example, 0.6 parts by weight to 0.7 parts by weight, based on 1 part by weight of the iridium metal powder. If the content of the alkali metal compound is less than 0.5 parts by weight based on 1 part by weight of the iridium metal powder, uniform oxidation may not occur during the sintering process due to insufficient adsorption of the alkaline component on the surface of the iridium metal. If it exceeds 1 part by weight, excessive alkali metal compounds can coat the iridium metal surface and prevent the oxidizing agent from contacting the iridium metal.

Alternatively, the mixture may include 1 part by weight to 3 parts by weight, for example 1.75 parts by weight to 2.25 parts by weight of alkali metal peroxide among the alkali metal compounds, based on 1 part by weight of iridium metal powder. If the content of alkali metal peroxide is less than 1 part by weight based on 1 part by weight of iridium metal powder, iridium metal may still remain after sintering due to lack of oxidizing agent. If it exceeds 3 parts by weight, iridium metal may be peroxidized to form iridium nanoparticles, making it difficult to obtain the product through the filter paper during the subsequent filtration process.

At this time, when the alkali metal compound includes a mixture of alkali metal hydroxide and alkali metal peroxide, a weight ratio of alkali metal hydroxide and alkali metal peroxide may be 1:2 to 1:4, for example, 1:2.5 to 1:3.5. If the weight ratio of alkali metal peroxide is less than 2, iridium metal may still remain after sintering due to lack of oxidizing agent, and if it exceeds 4, iridium nanoparticles are formed by peroxidizing iridium metal, which may make it difficult to obtain the product by passing through filter paper during the subsequent filtration process.

In the sintering step (S1-2), the mixture is sintered to produce alkali-containing iridium oxide.

The sintering may be performed at 750° C. or higher. If the sintering temperature is below 750° C., unreacted iridium metal may remain, and if the sintering temperature is 750° C. or higher, the iridium metal may be completely converted to alkali-containing iridium oxide. For example, the sintering may be accomplished by raising the temperature to 750° C. or higher for 5 to 10 hours and maintaining the temperature at 750° C. or higher for 2 to 4 hours.

The alkali-containing iridium oxide prepared through sintering may include a compound represented by Chemical Formula 1.

NaₓIr_{y}O_{z} [Chemical Formula 1]

In Chemical Formula 1, x is an integer from 2 to 4, y is an integer from 1 to 3, and z is an integer from 3 to 8.

For example, the alkali-containing iridium oxide represented by Chemical Formula 1 may include Na₂IrO₃, Na₄IrO₄, Na₄Ir₃O₈, or a mixture thereof.

Optionally, the alkali-containing iridium oxide obtained from the sintering step may be washed with water before washing with a hydrochloric acid aqueous solution (S1-3).

The water may be deionized water, distilled water, or ultrapure water, etc., for example, deionized water.

For example, the washing step of the alkali-containing iridium oxide may be performed with the water at 60° C. to 70° C. for 2 hours to 4 hours. If the washing step is performed at less than 60° C., the washing may not be completely performed, but alkali ions may remain, but if the temperature is greater than 70° C., the washing water is evaporated and concentrated. If the washing time is less than 2 hours, the washing may be completely performed, but if the washing time is greater than 4 hours, the work time may be unnecessarily long.

Optionally, after the water washing, a filtering step may be further included. For example, the filtering may be performed by filtering the water-washed solution with a paper filter at a high temperature.

In addition, optionally, after the filtering, the water washing may be performed again, and for example, hot water at 60° C. to 70° C. prepared in advance may be used for the washing after the filtering.

The water washing may remove some alkali metal ions from the alkali-containing iridium oxide, obtaining some iridium oxide. However, after the water washing, an alkali metal component of about 400 ppm or more may remain.

Accordingly, the washing with the hydrochloric acid aqueous solution (S1-4) is performed by washing the alkali-containing iridium oxide with the hydrochloric acid aqueous solution to reduce a content of the remaining alkali metal component to 10 ppm or less to prepare iridium oxide.

The hydrochloric acid aqueous solution may be at a concentration of 5% to 10%. If the hydrochloric acid aqueous solution is at a concentration of less than 5%, the washing may not be well effective, but alkali metals still may remain, but if the concentration is greater than 10%, even some iridium metal in addition to the alkali metals may be dissolved.

Optionally, after the washing with the hydrochloric acid aqueous solution, the filtering may be further included. For example, the filtering may be performed by using a paper filter to filter the solution washed with the hydrochloric acid aqueous solution in a high temperature state.

In addition, optionally, after the washing with the hydrochloric acid aqueous solution, the iridium oxide may be dried into a cake.

The drying may be performed at 100° C. or more for 12 hours to 24 hours. If the drying temperature is less than 100° C., the drying time may not only be prolonged, but also moisture may remain after the drying.

Through the washing with the hydrochloric acid aqueous solution, a content of the remaining alkali metal component may be reduced. Accordingly, the cake of iridium oxide may have the alkali metals in a content of less than or equal to 10 ppm, for example, 0 ppm to 5 ppm.

If the content of the alkali metals is greater than 10 ppm, the iridium chloride, a final product, may have not so high purity as to negatively affect a catalytic reaction, when a catalyst is prepared by using the same.

In the hydrochloric acid dissolution reaction step (S1-5), the iridium oxide is dissolved in hydrochloric acid under a pressure and then reacted to prepare iridium chloride hydrate.

Herein, a content of the hydrochloric acid may be 5 parts by weight to 15 parts by weight, for example, 8 parts by weight to 10 parts by weight based on 1 part by weight of the iridium oxide. If the content of the hydrochloric acid is less than 5 parts by weight based on 1 part by weight of the iridium oxide, the iridium oxide may not be 100% converted to iridium chloride due to insufficient content of chloride ions, but if the content of the hydrochloric acid is greater than 15 parts by weight, excessive energy costs may be incurred to evaporate the hydrochloric acid aqueous solution in the subsequent concentration process.

The hydrochloric acid dissolution reaction may be performed under a pressure, for example, in a pressure vessel. The pressurization may be performed under 5 pressures to 10 pressures, for example, under 6 pressures to 8 pressures. Because the pressure increases in proportion to a reaction temperature, there is no need to separately adjust the pressure, if the reaction is performed in the following temperature ranges.

In addition, the hydrochloric acid dissolution reaction may be performed at 130° C. to 170° C. for 2 hours to 6 hours, for example, at 150° C. to 170° C. for 2 hours to 4 hours under the pressure. If the hydrochloric acid dissolution reaction temperature is less than 130° C., the iridium oxide may not be 100% converted to iridium chloride, but if the temperature is greater than 170° C., the iridium chloride may be easily converted, but the pressure vessel may be corroded or deformed, which makes commercial application difficult. If the time is less than 2 hours, a conversation rate of the iridium chloride may be deteriorated, but if the reaction time is greater than 6, excessive energy costs may be incurred.

Optionally, filtering may be further included after the hydrochloric acid dissolution reaction.

Through the filtering, the iridium chloride hydrate prepared in the hydrochloric acid dissolution reaction may be obtained. For example, the filtering may be performed by using a paper filter for the hydrochloric acid dissolution reaction solution in a high temperature state. Herein, in order to recover the remaining solution, a rinse solution, for example, deionized water at minimum is used.

The prepared iridium chloride hydrate may be, for example, a compound expressed by Ha₂IrCl₆·xH₂O. The iridium chloride hydrate obtained from the hydrochloric acid dissolution reaction may be substantially completely dissolved, for example, 99.9% or more dissolved, wherein a content of alkali metals is 10 ppm or less.

The method of manufacturing the iridium chloride hydrate may increase a yield rate by inducing complete oxidation of iridium metals in the sintering step (S1-2), generate no nitrogen oxide in the washing step with the hydrochloric acid aqueous solution (S1-4) by using the hydrochloric acid aqueous solution alone as a solvent, reduce a content of alkali metals in the iridium chloride to 10 ppm or less before the pressurization reaction by using hydrochloric acid to remove the alkali metal component used as an oxidizing agent, and achieve the product with high purity by securing solubility of 99.9% or more without unreacted iridium through the pressurization reaction in the hydrochloric acid dissolution and reaction step (S1-5).

Optionally, the prepared iridium chloride hydrate may be concentrated to prepare the iridium chloride (S1-6).

For example, the concentration may performed through distillation under a reduced pressure.

The prepared iridium chloride may be, for example, a compound expressed by IrCl₄·xH₂O.

In the dispersion preparation step (S2), the prepared iridium chloride is mixed with a solvent and a pore control agent to prepare a dispersion.

The solvent may be an alcohol-based solvent such as ethanol, isopropanol, or a mixture thereof, for example, a mixed solvent of ethanol and isopropanol. If the mixed solvent of ethanol and isopropanol is used, compared with using each solvent alone, the iridium oxide (IrO₂), a final product, may be manufactured to have a smaller particle size. Herein, the isopropanol and ethanol may have a weight ratio of 4:6 to 6:4 and a molar ratio of 1:1 to 1:1.5, for example, 1:1.2 to 1:1.4.

The solvent may be mixed in an amount of 10 parts by weight to 20 parts by weight based on 1 part by weight of iridium chloride. If the solvent amount is less than 10 parts by weight, solubility of iridium chloride (IrCl₄) may decrease, and if it exceeds 20 parts by weight, subsequent removal of the solvent may take a long time.

The pore control agent serves to increase the specific surface area and pore volume of the iridium oxide prepared after the final heat treatment by widening a gap between iridium during the process of removing the solvent from the mixture of iridium chloride and solvent.

The pore control agent may be a compound including a benzene ring or a hydrocarbon compound having 6 to 10 carbon atoms, for example 1,2,3-trimethylbenzene, 1,2,4-trimethylbenzene, 1,3,5-trimethylbenzene, triethylbenzene, hexanol, xylene, toluene, butylacetate, octanol, or a mixture thereof.

In the case that the pore control agent is a hydrocarbon compound with 6 to 10 carbons, if the carbon number is greater than 10, viscosity of the dispersion may be increased, and the pore control agent may not be completely removed during the heat treatment, but if the pore control agent has less than 6 carbons, the pore control agent may not be clearly effective.

The iridium chloride and the pore control agent may have a molar ratio of 1:1 to 1:3. If the molar ratio of the pore control agent is greater than 3, because the iridium oxide may have a larger particle size and a smaller specific surface area due to rapid exothermicity during the subsequent heat treatment, but if the molar ratio is less than 1, the effect may not be clearly displayed.

Herein, the solvent and the pore control agent may be simultaneously mixed or individually mixed with the iridium chloride, for example, after mixing and stirring the iridium chloride and the solvent, the pore control agent may be additionally added thereto and then, stirred. Herein, the stirring time is not particularly limited, but if the stirring may be maintained for 1 hour, the iridium chloride may be completely dispersed.

In the ion exchange step (S3), the dispersion is mixed with an ion exchanging agent for ion exchange.

The ion exchanging agent is to exchange chloride ions in the iridium chloride with other ions in the solvent to widen a gap between iridium and iridium during the solvent removal process to reduce a size of iridium oxide produced after the final heat treatment and to increase its specific surface area and pore volume.

The ion exchanging agent may be any material capable of exchanging chloride ions of the iridium chloride and for example, include alkali metal nitrate which is easy to wash, such as KNO₃, NaNO₃, or a mixture thereof.

The iridium chloride and the ion exchanging agent may have a molar ratio of 1:5 to 1:10, for example, 1:6 to 1:8. If the ion exchanging agent has a molar ratio of greater than 10, because the ion exchanging agent may remain during the ion exchange reaction, after removing the solvent, a moisture-generating reaction may continuously occur, causing liquefaction before the subsequent heat treatment process, but if the ion exchanging agent has a molar ratio of less than 5, the chloride ions may not be completely exchanged.

The ion exchange may be performed at 70° C. to 90° C. If the ion exchange temperature is less than 70° C., ion exchange efficiency may be deteriorated, but if the ion exchange temperature is greater than 90° C., the solvent may be evaporated before the ion exchange reaction to proceed with powderization, also deteriorating an ion exchange rate.

The ion exchange may be achieved by stirring at the temperature for 5 hours or more. The stirring time is not particularly limited but if maintained for 5 hours or more, the iridium chloride may be completely ion-exchanged.

In the powder preparation step (S4), the solvent may be removed to prepare powder.

The solvent removal is achieved by drying at 200° C. or higher under a normal pressure atmosphere, wherein because an iridium nitrate compound may be reduced by the alcohol-based solvent and changed again to iridium metals, the solvent may be removed by vacuum-drying at a relatively low temperature of 150° C. to 180° C., for example, 160° C. to 170° C. for 12 hours or more.

In the solvent removal, if the drying temperature is less than 150° C., the solvent may not be completely removed, but if greater than 180° C., the solvent may be completely removed, but there may be no apparent advantage over increasing the temperature. In the solvent removal, the drying time is not particularly limited, but if maintained for 12 hours or more, the solvent may be completely removed.

In the heat treatment step (S5), the nitrate ions and the hydrocarbon-based pore control agent remaining after removing the solvent are removed.

A temperature of the heat treatment may be appropriately adjusted according to a pore volume and a specific surface area of the iridium oxide. For example, the heat treatment may be performed at 300° C. to 600° C., for example, 350° C. to 450° C. for 1 hour to 1.5 hours. If the heat treatment temperature is less than 300° C., the nitrate ions may not be completely removed, but if the heat treatment temperature is greater than 600° C., the iridium oxide may be agglomerated, reducing the pore volume and the high specific surface area.

In the heat treatment, a temperature increase and temperature maintenance time may vary depending on a state of a heat treatment furnace, but for example, the temperature may be increased at 2° C. to 3° C. per minute and maintained for 1 hour to 1.5 hours. If the temperature maintenance time is longer after the temperature increase, the iridium oxide is crystallized, increasing the pore size and decreasing the specific surface area, but if the temperature maintenance time is shorter, the iridium oxide may not be completely converted.

Optionally, after the heat treatment step, the washing and filtering may be further performed (S6).

The washing may be performed by using deionized water, distilled water, or ultrapure water, etc., for example, deionized water, and the filtering may be performed by using a paper filter for the washed solution. In addition, the washing and the filtering may be several times performed to 5 ppm of alkali ions in the produced iridium oxide.

Furthermore, optionally, after the washing and filtering, drying may be performed.

A temperature and time for the drying are not particularly limited but may be performed to have a moisture content of 1 wt % in the iridium oxide after the drying, for example, at 100° C. or higher for 12 hours to 24 hours. If the drying temperature is less than 100° C., the drying time may not only become longer, but also residual moisture may still exist after the drying.

The prepared iridium oxide may be hydrate (IrO₂·xH₂O) of the iridium oxide.

As the iridium oxide is prepared by using the pore control agent and the ion exchanging agent, the iridium oxide may have an average pore size of 2 nm to 5 nm, an average pore volume of 0.21 cm³/g to 0.25 cm³/g, and a specific surface area of 100 m²/g to 420 m²/g.

### DETAILED DESCRIPTION OF THE EMBODIMENTS

Hereinafter, specific examples of the present disclosure are presented. However, the examples described below are only for specifically illustrating or explaining the present disclosure, and the scope of the invention is not limited thereto.

### Preparation Example 1: Preparation of Iridium Chloride

13.5 g of NaOH powder and 40 g of Na₂O₂ powder are added to 20 g of Ir metal powder and then, physically mixed.

The mixed powder is placed in a crucible and then, sintered at 750° C. and slowly cooled. The sintering proceeds by increasing a temperature to 750° C. for 6 hours and maintaining it for 2.5 hours. In addition, a lid of the crucible sintering is open during the sintering.

The sintered powder is added to 500 ml of deionized water for washing and then, filtered to remove potassium and sodium.

Subsequently, the obtained powder is additionally washed by using 200 g of a HCl solution diluted to 5% with deionized water, transferred to a drier, and dried at 100° C. for 12 hours to obtain powder.

The powder is placed in a pressure vessel, and 250 g of HCl is additionally added thereto and then, mixed.

The pressure is placed in a heat treatment furnace for a high temperature pressurization reaction at 150° C. for 4 hours and then, cooled. Then, when the pressure vessel is open, the powder is all dissolved and exists in a solution state.

The solution is distilled under a reduced pressure at 80° C. until it becomes powder again, finally obtaining an iridium chloride precursor

### Preparation Example 2: Preparation of Iridium Oxide

### Example 1

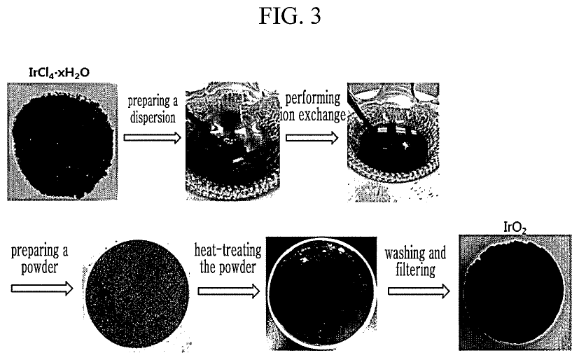

FIG. 3 is a photograph showing the products at each stage of manufacturing iridium oxide in Example 1. Referring to FIG. 3, a process of manufacturing the iridium oxide of Example 1 is described.

10 g of the iridium chloride powder according to Preparation Example 1, 75 g of each of ethanol and isopropanol as a solvent, and subsequently, 7 g of trimethylbenzene as a pore control agent are added to a water boiler capable of stirring and then, stirred for 1 hour to disperse the mixture.

When the stirring is sufficiently performed and completed, 20 g of potassium nitrate as an ion exchanging agent is added thereto and then, heated to 80° C. and then, stirred for 5 hours to perform an ion exchange process.

When the ion exchange is completed, the mixture is transferred to a vacuum drier and then, heated to 170° C. to dry and completely remove the solvent for 12 hours, obtaining powder.

Subsequently, the powder is transferred to a heat treatment furnace and maintained at 350° C. for 1 hour to remove any remaining organic compound.

Finally, the heat-treated powder is repeatedly washed with deionized water and filtered to remove remaining potassium ions and then, dried at 100° C. for 24 hours.

As a result of X-ray diffraction (XRD) analysis of the prepared iridium oxide, the iridium oxide turns out to have a composition of IrO₂·xH₂O with an amorphous crystal structure, and as a result of BET analysis, the iridium oxide has a specific surface area of 412 m²/g, a pore volume of 0.24 cm³/g, and a pore size of 2.5 nm.

### Examples 2 to 4 and Comparative Examples 1 to 4

Each iridium oxide of Examples 2 to 4 and Comparative Examples 1 to 4 is prepared in the same manner as in Example 1 except that the reaction conditions in Example 1 are changed as shown in Table 1.

TABLE 1

| | | | | | | Preparation step | | |
|---|---|---|---|---|---|---|---|---|
| | | | | Pore | Ion | Ion | Vacuum | Heat |
| | | | | control | exchanging | exchange | drying | treatment |
| | IrCl₄ | Solvent(g) | | agent | agent | temperature | temperature | temperature |
| | (g) | Ethanol | Isopropanol | (g) | (g) | (° C.) | (° C.) | (° C.) |
| Example1 | 10 | 75 | 75 | 7 | 20 | 80 | 170 | 350 |
| Example2 | 10 | 75 | 75 | 7 | 20 | 80 | 170 | 400 |
| Example3 | 10 | 75 | 75 | 7 | 20 | 80 | 170 | 450 |
| Example4 | 10 | 75 | 75 | 7 | 20 | 80 | 170 | 500 |
| Comparative | 10 | 75 | 75 | 0 | 20 | 80 | 170 | 350 |
| Example1 | | | | | | | | |
| Comparative | 10 | 150 | 0 | 7 | 20 | 80 | 170 | 350 |
| Example2 | | | | | | | | |
| Comparative | 10 | 0 | 150 | 7 | 20 | 80 | 170 | 350 |
| Example3 | | | | | | | | |
| Comparative | 10 | — | — | — | — | — | — | 350 |
| Example4 | | | | | | | | |

For reference, Examples 2 to 4 are cases of changing the heat treatment temperature, Comparative Example 1 is a case of adding no pore control agent, Comparative Examples 2 to 3 are cases of using a single solvent, and Comparative Example 4 is a case of directly performing the heat treatment without the process of forming pores of the iridium chloride precursor.

### Experimental Example: Characteristic Analysis of Iridium Oxide

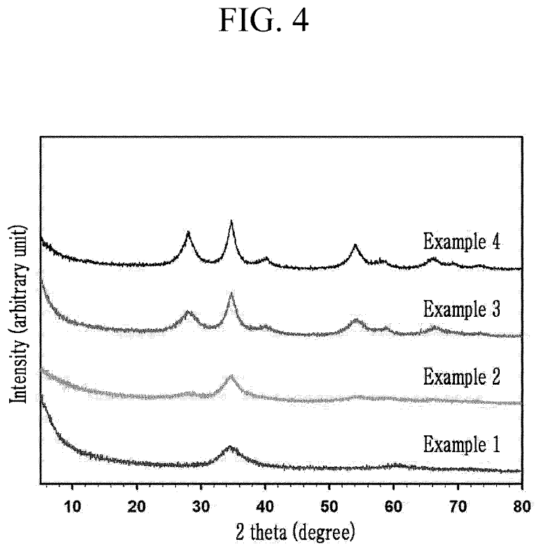

After performing X-ray diffraction analysis (XRD) and BET analysis of each iridium oxide of the examples and the comparative examples, the results are shown in Table 2 and FIG. 4.

TABLE 2

| | XRD | BET analysis result | | |
|---|---|---|---|---|
| | analysis | Specific surface | Pore volume | Pore size |
| | result | area (m²/g) | (cm³/g) | (nm) |
| Example1 | amorphous | 412 | 0.24 | 2.5 |
| Example2 | amorphous | 307 | 0.22 | 3.7 |
| Example3 | crystalline | 150 | 0.20 | 5.7 |
| Example4 | crystalline | 86 | 0.11 | 6.2 |
| Comparative | amorphous | 233 | 0.21 | 3.8 |
| Example1 | | | | |
| Comparative | amorphous | 162 | 0.20 | 4.7 |
| Example2 | | | | |
| Comparative | amorphous | 198 | 0.20 | 4.1 |
| Example3 | | | | |
| Comparative | amorphous | 64 | 0.09 | 6.5 |
| Example4 | | | | |

Referring to Table 2 and FIG. 4, as a result of performing the crystallinity analysis (XRD analysis) of the products of Examples 1 to 4, as the heat treatment temperature is increased, the iridium oxide is gradually converted into a crystalline material with a smaller specific surface area and a smaller pore volume but a larger particle size due to agglomeration phenomenon of the iridium oxide.

Based on the above results, an intermediate product with an expanded pore volume (powder before the heat treatment) by introducing a pore control agent, as a heat treatment temperature is increased, goes through collapse of particle skeleton and is changed to a material with a low specific surface area and a low pore volume.

In addition, Example 1 and Comparative Example 1 are the results of comparing a pore distribution with and without using a pore control agent. Comparative Example 1, in which the pore control agent is not used, exhibits a very low specific surface area and a very low pore volume, compared with Example 1. The reason is that the pore control agent creates and maintains a porous shape by providing a micro skeleton, when the iridium oxide intermediate is formed.

Example 1 and Comparative Examples 2 to 3 are the results of comparing a method of using solvents, which are mixed with the iridium chloride powder. Unlike Example 1, Comparative Examples 2 to 3, in which ethanol or isopropanol as a single solvent is used, exhibit that the pore control agent is not effective even under the same conditions such as the ion exchange or the heat treatment, which are confirmed to be disadvantageous in forming pores, wherein the reason is expected to come from a difference solubility or bond strength between the solvent and the pore control agent.

Example 1 and Comparative Example 4 are the results of comparing products obtained when the heat treatment is simply performed without using the pore control agent and the ion exchanging agent. Unlike Example 1, Comparative Example 4, in which the pore control agent is not added, exhibits low pore characteristics despite a low heat treatment temperature. Accordingly, in order to manufacture iridium oxide with a high pore volume and a high specific surface area, a primary process of creating micropores should be necessarily performed, and an appropriate heat treatment temperature is required to maintain the micropores.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

Provided is a method for easily commercially preparing iridium oxide with high pore volume and high specific surface area as a catalyst for oxygen generation reaction that can be used in fuel cells and water electrolysis reactions.

1. A method for preparing iridium oxide, comprising
preparing iridium chloride,
mixing iridium chloride, a solvent, and a pore control agent to prepare a dispersion,
mixing the dispersion with an ion exchanging agent and performing ion exchange,
removing the solvent from the dispersion to prepare a powder, and
heat-treating the powder.

2. The method of claim 1, wherein
the preparing of the iridium chloride includes
preparing a mixture of iridium metal powder and an alkali metal compound,
firing the mixture to prepare alkali-containing iridium oxide,
washing the alkali-containing iridium oxide with an aqueous hydrochloric acid solution to obtain iridium oxide, and
dissolving the iridium oxide in hydrochloric acid under pressure and then performing a reaction.

3. The method of claim 2, wherein
the alkali metal compound includes alkali metal hydroxide, alkali metal peroxide, or a mixture thereof.

4. The method of claim 3, wherein
the alkali metal hydroxide includes sodium hydroxide, potassium hydroxide, lithium hydroxide, or a mixture thereof, and
the alkali metal peroxide includes sodium peroxide, potassium peroxide, lithium peroxide, or a mixture thereof.

5. The method of claim 2, wherein
the alkali-containing iridium oxide includes a compound represented by Chemical Formula 1:
NaₓIr_{y}O_{z} [Chemical Formula 1]
wherein, in Chemical Formula 1, x is an integer from 2 to 4, y is an integer from 1 to 3, and z is an integer from 3 to 8.

6. The method of claim 2, wherein
in the washing of the alkali-containing iridium oxide with an aqueous hydrochloric acid solution, a concentration of the hydrochloric acid aqueous solution is 5% to 10%.

7. The method of claim 2, wherein
the dissolving in hydrochloric acid and reacting is performed under 5 to 10 pressures at 130° C. to 170° C. for 2 to 6 hours.

8. The method of claim 1, wherein
in the preparing of the dispersion, the solvent is an alcohol-based mixed solvent.

9. The method of claim 8, wherein
the alcohol-based mixed solvent includes ethanol and isopropanol.

10. The method of claim 9, wherein
a weight ratio of isopropanol and ethanol is 4:6 to 6:4.

11. The method of claim 1, wherein
in the preparing of the dispersion, the solvent is mixed in an amount of 10 to 20 parts by weight based on 1 part by weight of iridium chloride.

12. The method of claim 1, wherein
the pore control agent is a compound including a benzene ring or a hydrocarbon compound having 6 to 10 carbon atoms.

13. The method of claim 12, wherein
the pore control agent includes 1,2,3-trimethylbenzene, 1,2,4-trimethylbenzene, 1,3,5-trimethylbenzene, triethylbenzene, hexanol, xylene, toluene, butylacetate, octanol, or a mixture thereof.

14. The method of claim 1, wherein
molar ratio of iridium chloride and the pore control agent is 1:1 to 1:3.

15. The method of claim 1, wherein
the ion exchanging agent is alkali metal nitrate.

16. The method of claim 1, wherein
a molar ratio of iridium chloride and ion exchanger is 1:5 to 1:10.

17. The method of claim 1, wherein
the ion exchange is performed between 70° C. and 90° C.

18. The method of claim 1, wherein
the preparing of the powder is performed by drying at 150° C. to 180° C. for 12 hours or more.

19. The method of claim 1, wherein
the heat-treating is performed at 300° C. to 600° C. for 1 hour to 1.5 hours.

20. The method of claim 1, wherein
the prepared iridium oxide has
an average pore size of 2 nm to 5 nm,
an average pore volume of 0.21 cm³/g to 0.25 cm³/g, and
a specific surface area of 100 m²/g to 420 m²/g.
